(19) United States
(12) Patent Application Publication
(10) Pub. No.: US 2004/0074264 A1
(43) Pub. Date: Apr. 22, 2004

(54) Secure attachment of portable data storage device

(75) Inventors: Gary Kung, (US); Tom Learmonth, (US)

Correspondence Address: John Chupa and Associates PC, 28535 Orchard Lake Rd Suite 50, Farmington Hills, MI, 48334, US

(73) Assignee: I/O INTERCONNECT, INC.

(21) Appl. No.: 10/273,775

(22) Filed: Oct. 18, 2002

(51) Int. Cl. E05B 73/00

(52) U.S. Cl. 70/58; 70/30

(57) ABSTRACT

A portable data storage device (1), sometimes referred to as a “pen drive”, “thumb drive” or “USB key-ring storage”, attaching securely to a key-ring (2) while carried by the user, or attaching securely to a computer-tethered security cable (5), such as that described in U.S. Pat. No. 6,305,197, when left unattended to deter theft. The portable storage device attaches to a security cable (5) without the need to unlock said security cable's lock (17). A physical key device (3) or (alpha) numeric key number for a combination lock (4) is used to release the portable storage device from the computer tethered security cable (5) or key-ring (2).

### BACKGROUND OF THE INVENTION

Key-ring USB portable storage devices consist mainly of flash memory chips arranged in type and quantity to provide typical memory storage area sizes from 32 Mbytes to 2 Gbytes and above. The devices connect to computers through a standard USB (Universal Serial Bus) connection; thus allowing easy sharing of files between different computers. Previously this functionality would have utilized 3.5 inch diskettes, but their standard capacity is limited to 1.44 Mbytes. Modern file sizes are often much larger and although higher capacity diskette formats were tried they did not gain popular mass appeal and widespread use.

While the small size of a key-ring USB portable storage device is very convenient for the user, it does however present a temptation for theft; the value of these devices is significant (the largest memory sizes are typically half the cost of a mid-range popular brand laptop computer). To reduce the risk of theft it is desirable for the user to employ some security measures to at least make it more difficult for a potential thief to remove the device if it is left unattended plugged into a computer or a keychain.

Tethered security cables are becoming popular since the same security risk is associated with laptop and desktop computers, plus potentially valuable peripheral devices such as DVD Writers. A tough steel cable is terminated at one end with a securing attachment to an anchor point on the valuable item and the other cable end is terminated with a locking device which attaches securely to the anchor point. The steel cable is arranged to loop around some large, preferably immovable object thus rendering the valuable item more difficult to steal. One such cable system is made by Kensington, San Mateo, Calif. described in U.S. Pat. No. 5,502,989 for example.

### SUMMARY OF THE INVENTION

In accordance with one embodiment of the invention, an ideal solution is provided when the unlocking device which is carried by the user, separately from the USB portable storage device. This can be accomplished automatically if the key-ring attached device cap becomes the unlocking key. The cap is not required when the USB portable storage device is plugged into the computer's USB receptacle, so it can remain on the key-ring carried by the user. A safety cable tethered to the computer can be routed to pass through the locking clip on the USB portable storage device, to physically restrict its removal and theft. A slot with a width of at least 6 mm is required to accommodate a bare steel cable, while a slot of 11 mm width is required to accommodate a plastic sleeved type of steel cable.

The user either captures the steel cable in the latch by a snapping action or opens up the latch with the use of the key-ring mounted cap. There is no need to unlock the security cable's lock.

Many different cap lock combinations could be made, so that the USB portable storage device and cap would be to an extent different to other USB portable storage devices, depending upon how many coding key elements were used.

The USB portable storage device could be removed by unlocking the steel security cable, but many such cables have either a cable loop or a metal end of such size that the end of the cable would not fit through the clip on the USB portable storage device.

An additional consideration is that the security cable may belong to another person, so the key may not be available for use.

In a second embodiment a similar security arrangement can be achieved by the use of a combination lock mounted on the USB portable storage device. The key in this case is a number or sequence of characters, carried by the user.

The novel features of the invention are set forth with particularity in the appended claims. The invention will be best understood from the following description when read in conjunction with the accompanying drawings.

### BRIEF DESCRIPTION OF THE DRAWINGS

FIG. 1 is a view of a USB Portable Storage device attached to a key-ring. The device could be attached by snapping and locating into a cap which was itself 10 attached to the key-ring, or as the view shows the device could attach directly.

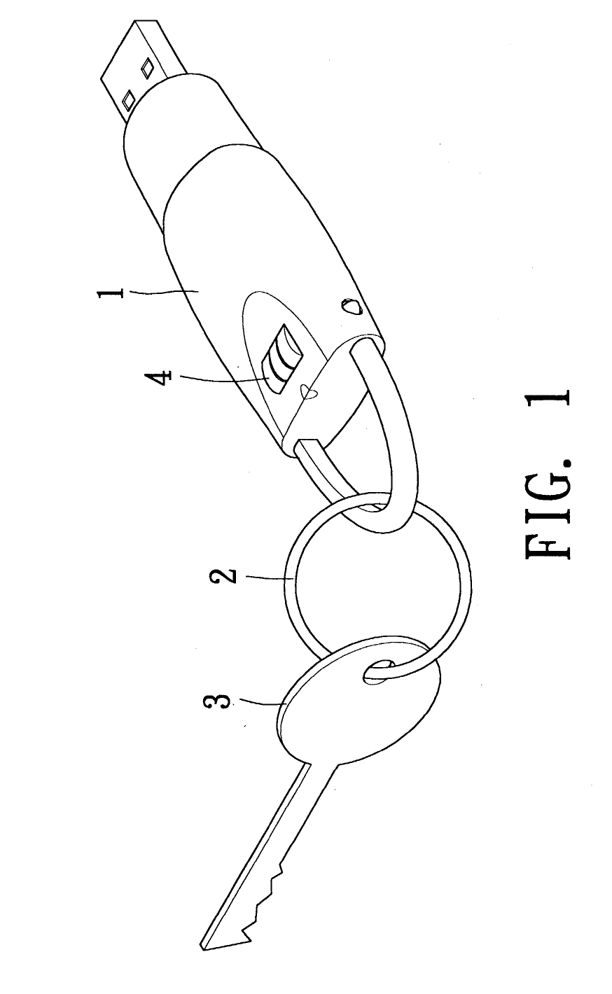

FIG. 2 is a view of how a security cable is used with the USB portable storage device to deter theft. The latch on the portable storage device can't be operated without a specific key.

FIG. 3 depicts an embodiment wherein a cap can unlock a latch for the capture or release of a safety cable. Note only one latch element is shown.

FIG. 4 shows a cap positioned to unlock the latch.

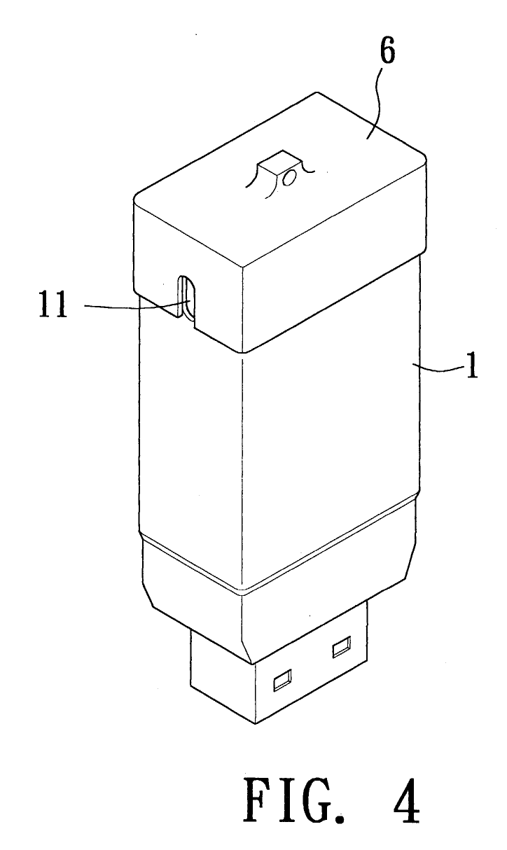

FIG. 5 shows a steel cable located in the latch slot.

FIG. 6 shows a top view of a latch assembly, comprising 3 latches.

FIG. 7 lists the possible latch codes for a 3 way latch combination.

FIG. 8 shows how a secret pin number on the device housing is revealed.

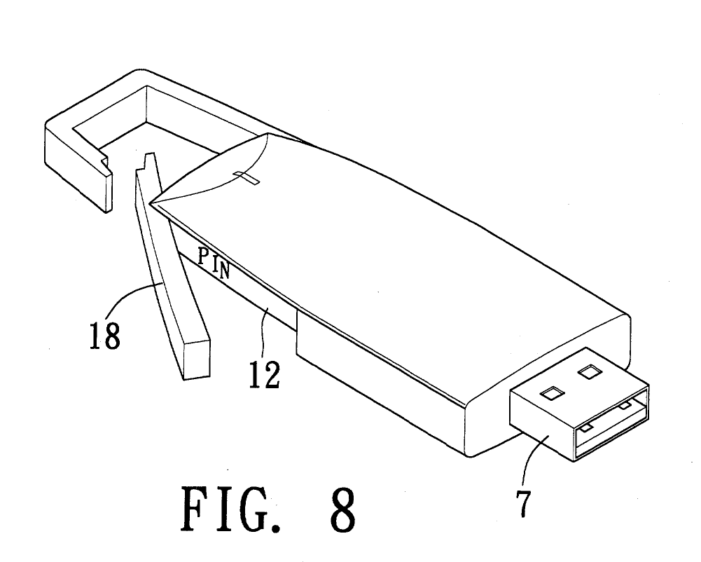

FIG. 9 an exploded view of the device's housing when unlocked, allows removal or replacement of it's internal mounted circuit board assembly.

FIG. 10 shows an arrangement to lock a USB plug into a USB socket receptacle.

### DESCRIPTION OF THE PREFERRED EMBODIMENTS

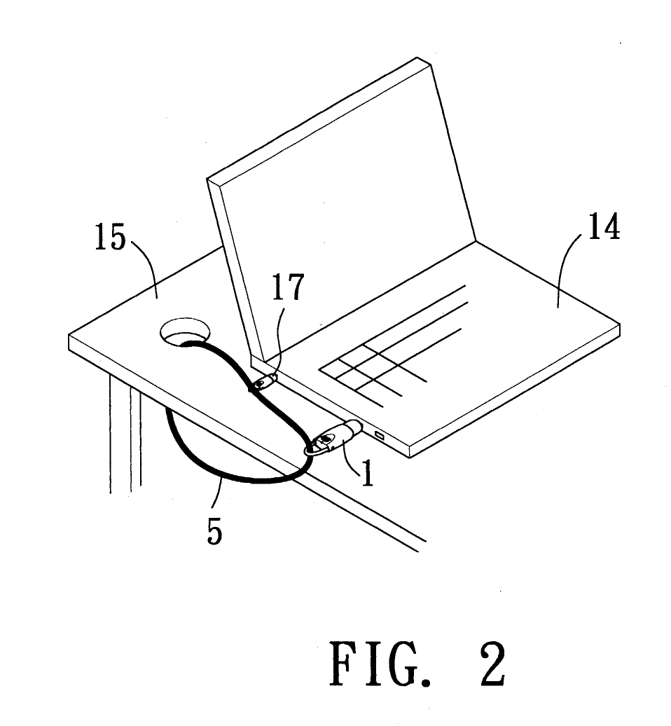

FIG. 2 illustrates a USB portable storage device 1 tethered by a security cable 5 to the computer 14 into which it is plugged. The steel cable 5 is captured by the USB Portable Storage device 1 when no need of unlocking the cable. Capturing the cable can be with or without the aid of a key. Unlocking of the USB portable storage device 1 latch however is only allowed with a physical key or (alpha) numerical code sequence remembered by the user. This method ensures a fast, efficient security protection to be employed without undue inconvenience to the user.

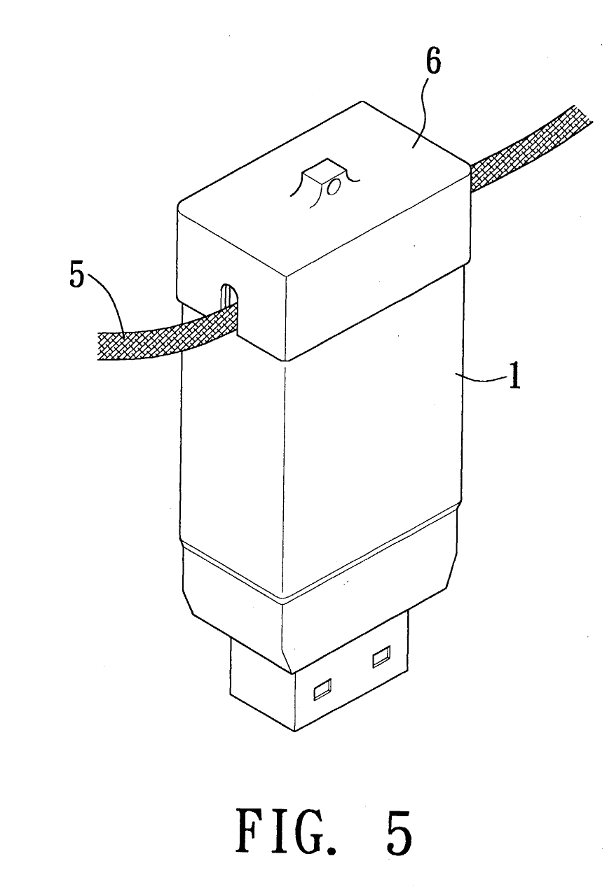

FIG. 5 shows another embodiment wherein the USB portable storage device's cap 6 is the key. The cap 6 remains attached to the user's key-ring 2. The cap 6 is used to capture and release the steel security cable 5 by opening the latches 9 on the USB portable storage device 1.

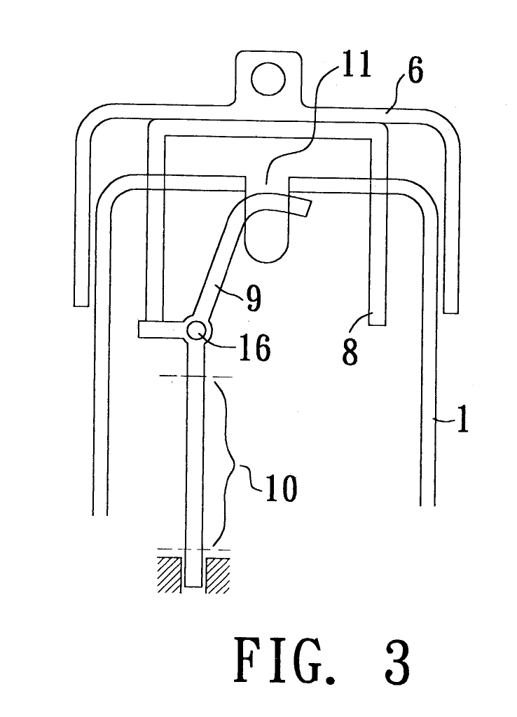

The cap 6 has fixed inside a ‘key code’ metal forming part 8, shown in FIG. 3. Each selectively loaded finger of the formed key code part 8 act upon a latch 9 lever, causing the latch 9, made of plastic, to flex its lower portion 10 and pivot around point 16. The latch pivoting causes the latch upper curved portion to open the security cable slot 11, for either capturing or releasing the cable 5.

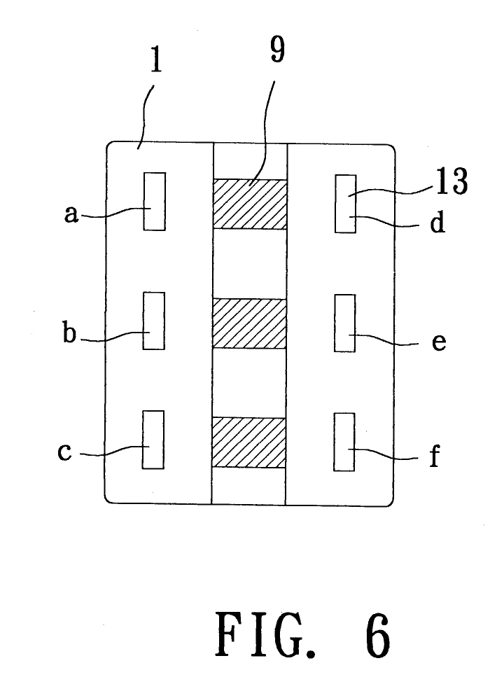

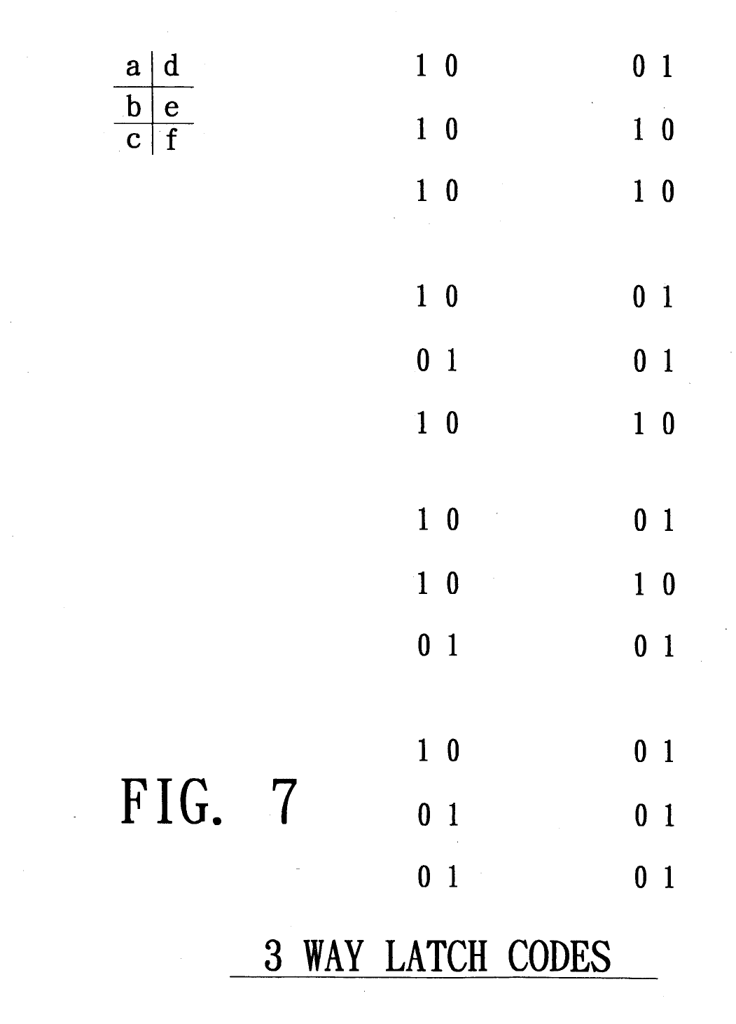

Latches 9 are loaded into the USB portable storage device 1 in both right hand looking and left hand looking combinations this is the method of coding the device. FIG. 6 shows a top view of three latches loaded in a USB portable storage device 1, and the six key code slots 13 where the cap 6 key code fingers 8 locate. Each key code metal part 8 would have only three fingers present. FIG. 7 lists the key code combinations that are possible with three latches 9, and three key code part 8 fingers. Eight combinations are possible with three latches 9.

The key code slots 13 should be made deep so that it not clear on inspection which latch orientations are loaded, and therefore not providing insight how to defeat the lock.

The plastic latch 9 upper formed arc, blocking the exit of the cable, should extend comfortably over the slot 11 width, thereby providing resistance against efforts to pull the cable 5 out of the slot 11.

Although the latch 9 could be formed from plastic, it could also be made from metal and pivot under spring force provided by a cantilever arrangement or spring compression for example. A metal latch would offer more physical durability but may increase parts count if a spring was required.

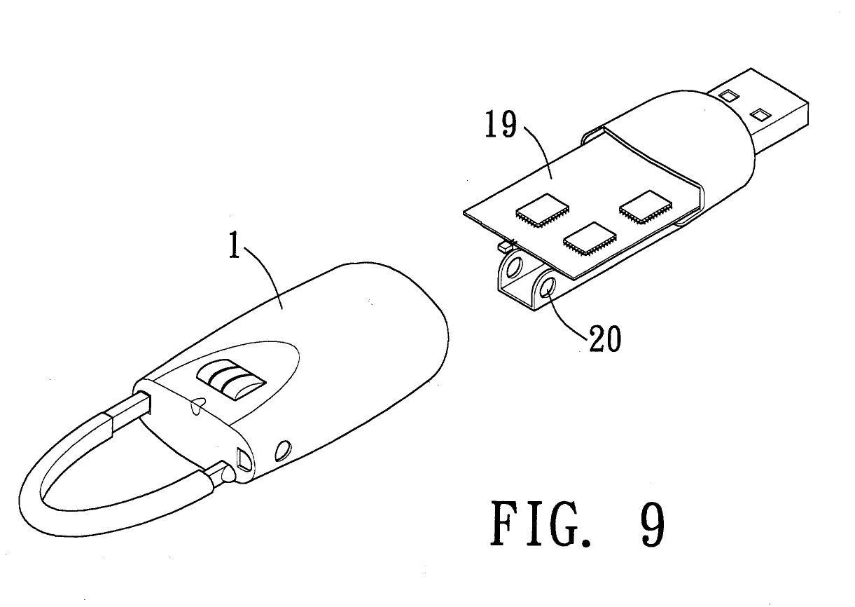

A further embodiment shown in FIG. 9 is for the lock latches to actuate a mechanical retainer 20 release for the USB portable storage device 1 housing to release the internal circuit board 19 which carries the memory chips. This would allow the user to upgrade memory size for example, or to partially disassemble the device upon disposal so that the materials can be segregated by ‘material type’ for recycling.

A further embodiment concerns identification of the owners' details on the outer surface of the device. The code key can actuate a transparent sleeve, or window, to be removable to gain access to a write-able area where the user can mark some identification details.

A further embodiment is for the key code to actuate a normally locked door 18 to reveal a PIN number or security code 12; such a code could for example be used to gain conditional access to a web space where the user would back-up the data files stored on the device. The owner would have access to the data as long as he had the device, regardless if it was electrically functional or not.

Another use for the revealed code could be to enable a program to run, providing verification that the user was entitled to make use of the software. The software could be resident on the USB portable storage device or not.

A further embodiment could be for the code key to allow addition or replacement of different styling appearance—to change the device's look in terms of color or artwork for example.

A further embodiment could be for the code key to actuate the USB plug connector 19 to retract or release. Once the USB plug 19 was retracted the device could not easily be connected to a computer, thus offering a degree of protection for the data files stored on the device.

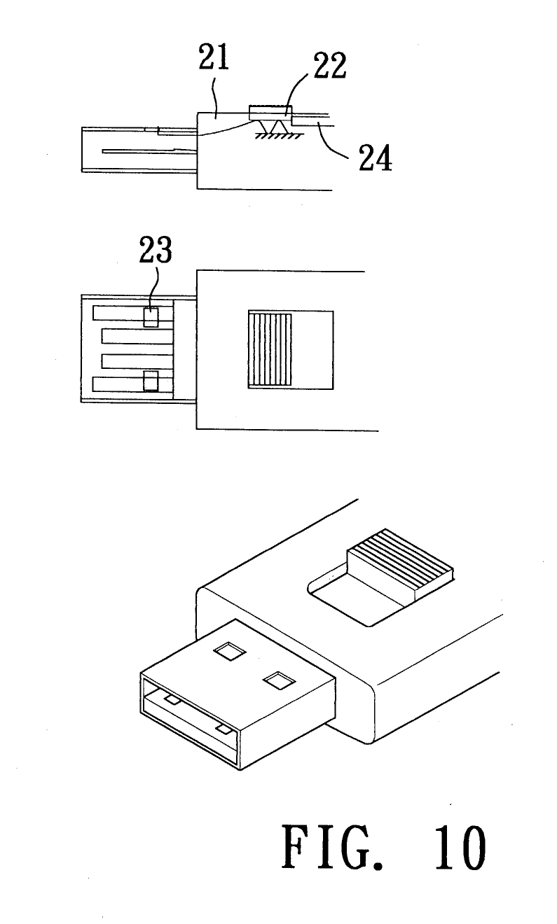

In a further embodiment the USB portable storage device 1 can lock into the computer via the USB socket mounted on the computer. FIG. 10 illustrates how the rectangular holes 23 specified in the USB standard can be captured by spring blades 21, under controlling of a push-in and slide button 22 when the device latch is unlocked. A pushrod 24 allows the button 22 to slide in a manner to unlock the spring blades only when the device's latch is unlocked.

Those skilled in the art would appreciate that other serial interface connections such as Firewire IEEE1394, Serial ATA, wired networks such as 802.3 Ethernet and wireless networks such as IrDA Infra Red or WiFi IEEE802.11 can all be used in place of the USB connection.

Those skilled in the art would recognize that many physical implementations could be realized for the latch mechanism, and number of latch code elements.

While the invention has been described with reference to a preferred embodiment thereof, it is to be understood that modifications or variations may be easily made without departing from the spirit of this invention, which is defined by the appended claims.

What is claimed is:

1. A secure attachment of portable data storage device having a selective code activated locking device; said locking device captures and traps a security cable, at a point along its length thereby eliminating the need to unlock the end of the security cable and passing it through the portable data storage device latch.

2. A secure attachment of portable data storage device as claimed in claim 1, wherein the locking latch is designed to capture, or release, a steel security cable without unlocking the security cable first; with a physical key-ring attached coded key; said physical key-ring coded fingers in a cap arranged to act upon plastic flexing latch elements in the top of the device housing through a series of holes.

3. A secure attachment of portable data storage device as claimed in claim 1, wherein said device has a built-in (alpha) numeric combination lock to activate the locking device to capture, or release, a steel security cable without unlocking the security cable first; said combination lock consisting of a series of dials carrying markings (numeric or other), with only one combination aligning a hole trough the series of dials; said hole mechanically causes the latch to be unlocked.

4. A secure attachment of portable data storage device as claimed in claim 1, said device reveals a secret PIN number upon being unlocked; a pin number is marked on the device's housing behind the latch, on unlocking of the latch the PIN number is visible.

5. A secure attachment of portable data storage device as claimed in claim 1, wherein the housing of said device opens up once the latch is unlocked, to mechanically allow removal and/or replacement of the printed circuit board assembly inside.

6. A secure attachment of portable data storage device as claimed in claim 1, wherein a plastic formed fascia sleeve slides over the device housing to mechanically lock in place; said fascia can only be removed by unlocking the device's latch.

7. A secure attachment of portable data storage device as claimed in claim 1, wherein an USB plug connector mounted at one end of the device housing is movable, such that it mechanically retracts when pushed inwards towards the housing against a spring force; said device's latch releases the spring loaded USB plug connector when unlocked.

8. A secure attachment of portable data storage device as claimed in claim 1, wherein a locking blades within the USB plug connector locate into slots inside the computer's USB receptacle socket; said blades are retracted upon the device's latch being unlocked.
